(19) United States
(12) Patent Application Publication
(10) Pub. No.: US 2008/0303505 A1
(43) Pub. Date: Dec. 11, 2008

(54) Self Tuning High Voltage Power Supply

(76) Inventors: Kenneth E. Wing, Alpine, CA (US); Eliahu Weinstein, San Diego, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/660,185

(22) PCT Filed: Apr. 20, 2005
(86) PCT No.: PCT/US2005/013482

§ 371 Date: Aug. 12, 2008

Related U.S. Application Data
(60) Provisional application No. 60/564,008, filed on Apr. 20, 2004.

(51) Int. Cl. H01F 21/00

(52) U.S. Cl. 323/355

(57) ABSTRACT

A self tuning high voltage power supply comprising a signal generator that emits a variable frequency signal, an amplifier that receives the variable frequency signal and emits an amplified variable frequency signal, and a transformer that receives and steps up the amplified variable frequency signal, creating an output voltage that corresponds to a desired voltage. A measuring unit measures the power consumed by the amplifier and provides a reading to a processing unit, which receives such reading and tunes the signal generator to emit a variable frequency signal that is at the frequency of resonance of the transformer. This causes the transformer to operate at conditions of resonance and to substantially eliminate power losses due to stray capacitance and stray inductance. As a consequence, the self tuning high voltage power supply can deliver the desired voltage with minimum power consumption.

### FIELD OF THE INVENTION

The present invention relates to an electrical power supply, and, more particularly, to a self tuning high voltage power supply wherein the power losses related to stray capacitance and stray inductance are substantially eliminated.

### BACKGROUND OF THE INVENTION

Power supplies convert electrical power having one set of characteristics to electrical power having another set of characteristics, in order to meet specified output requirements. Generally, power supplies are employed in the operation of electronic equipment such as fuel cells, laser printers, PCB mount DC-DC converters, photo multipliers, X-ray sources, and in certain types of precision scientific equipment, in order to convert raw input power to a controlled or stabilized voltage and/or current.

In conventional high voltage power supplies, the weights, sizes, and power losses of the power supplies are dominated by the windings of the transformer that steps up the voltage. Large voltage step-ups require a large number of turns in the secondary winding of the transformer, causing substantial power losses due to the large amounts of stray capacitance and stray inductance (collectively, “the stray parameters”) that develop between the turns and that produce heat in the driving circuitry that must be dissipated with large cooling fins. The effect of these stray parameters is not constant, but varies instead over time with the aging of the components and of the insulation system, and also with environmental changes such as changes in temperature, moisture, and altitude. Therefore, conventional power supplies with large voltage step-ups are not only costly to build and to install, but are also inherently inefficient due to operational power losses related to the stray parameters, to time of use, and to environmental conditions.

Sometimes a plurality of power supplies is arranged in a sequence either to meet specific design requirements or to reduce the size and the heat generation associated with large transformers. For instance, a primary power supply may operate as an inverter of AC power into DC power, and a secondary power supply may operate as a non-inverter stepping up DC power into DC power, or as an inverter stepping up DC power into AC power. One such example is fuel cells, such as those utilized in hybrid cars, where DC power is provided by a battery and must be stepped up to AC power in order to operate the vehicle. In printers instead, DC power that is otherwise available within the printer must be stepped up to AC power to operate certain printing mechanisms. While using a plurality of smaller power supplies to replace a larger power supply alleviates the problems associated with size and with the stray parameters, the problems of power dissipation, heat generation, and inefficient operation over time and under different environmental conditions remain yet unresolved, and are most pronounced as the ratio of the secondary to the primary winding turn counts increases, that is, as the difference in the number of turns between the primary winding of the transformer and the secondary winding becomes more pronounced. In a printer, for example, a secondary power supply may still require a transformer that has a secondary winding with 7600 turns.

The most efficient operation of a power supply is achieved when the transformer in the power supply operates at the frequency of resonance, that is, when the capacitive reactance and the inductive reactance of the transformer cancel each other out. The frequency of resonance is not constant, but depends instead both on the desired output voltage, and also on a variety of other operational and environmental conditions.

Therefore, there is a need for a high voltage power supply that is capable of stepping power up with lower power dissipation, higher operational efficiencies, a reduced heat sink structure in the component parts, and a less expensive construction than in the prior art.

There is a further need for a high voltage power supply that can tune itself to operate at the frequency of resonance regardless of operational and environmental conditions, thereby eliminating the power losses related to stray capacitance and inductance.

### SUMMARY OF THE INVENTION

A self tuning high voltage power supply is provided comprising a signal generator that emits a variable frequency signal, an amplifier that receives the variable frequency signal and emits an amplified variable frequency signal, and a transformer that receives and steps up the amplified variable frequency signal, creating an output voltage that corresponds to a desired voltage. A measuring unit measures the power consumed by the amplifier and provides a reading to a processing unit, which receives such reading and which tunes the signal generator to emit a variable frequency signal that is at the frequency of resonance of the transformer. This causes the transformer to operate at conditions of resonance and to eliminate all power losses due to stray capacitance and stray inductance. As a consequence, the self tuning high voltage power supply can deliver the desired voltage with minimum power consumption.

In one embodiment of the invention, a feedback network is also provided that causes the amplifier to transmit the amplified variable frequency signal to the transformer at a frequency level appropriate to maintain the voltage output at a constant level under different operating and environmental conditions.

A method for generating a self tuning high voltage power supply is further provided, which comprises the steps of generating a variable frequency signal, of amplifying the variable frequency signal to provide an amplified variable frequency signal, and of stepping up the amplified variable frequency signal by means of a transformer, so to create an output voltage that corresponds to a desired voltage. The power consumed by the amplifier is measured and a reading is generated. That reading is then processed to tune the variable frequency signal to the frequency of resonance of the transformer, making it possible to recover, and to deliver to the load, substantially all power otherwise lost to stray capacitance and to stray inductance in the transformer, so that the self tuning high voltage power supply can provide the desired voltage with minimum power consumption.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram illustrating a first embodiment of a self tuning high voltage power supply in accordance with the present invention, wherein the first embodiment includes a DC power input and an AC output.

FIG. 2 is a block diagram illustrating a second embodiment of a self tuning high voltage power supply in accordance with the present invention, wherein the second embodiment includes a DC power input and a DC output.

FIG. 3 is a detailed circuit diagram of a variable frequency oscillator, representing an example of the signal generator included in the present invention.

FIG. 4 is a summary circuit diagram of an integrated circuit power amplifier, representing one example of the amplifier included in the present invention.

FIG. 5 is a detailed circuit diagram of a car stereo amplifier circuit, representing another example of the amplifier included in the present invention.

FIG. 6 is a summary circuit diagram of a step up transformer circuit, possessing normal stray parameters and representing one example of the transformer circuit included in the present invention.

FIG. 7 is a summary circuit diagram of a set of capacitors, representing one example of a set of electrostatic discharge elements employed in a laser printer and providing the load in the present invention.

FIGS. 8A-8B are detailed circuit diagrams of power supply measuring circuits, representing examples of measuring units included in the present invention. More particularly, FIG. 8A illustrates a circuit wherein the power consumed by the amplifier is measured by means of a sampling resistor inserted in the Vₑₑ line, and FIG. 8B illustrates a feedback network that generates a feedback signal (shown as HV CTRL or Volume) causing a constant voltage output from the self tuning high voltage power supply when the feedback signal is applied to the variable gain input of the amplifier.

FIG. 9 is a schematic diagram illustrating the function blocks of a microprocessor included in the processing unit of one embodiment of the present invention.

FIG. 10 is a chart showing in qualitative terms the graphical relationship between the power consumed by the amplifier, as measured at the sampling resistor, and further showing the frequency selected during the tuning routine and the frequency of resonance at which power losses are minimized.

### DETAILED DESCRIPTION OF THE PREFERRED EMBODIMENTS

Detailed descriptions of embodiments of the present inventions are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

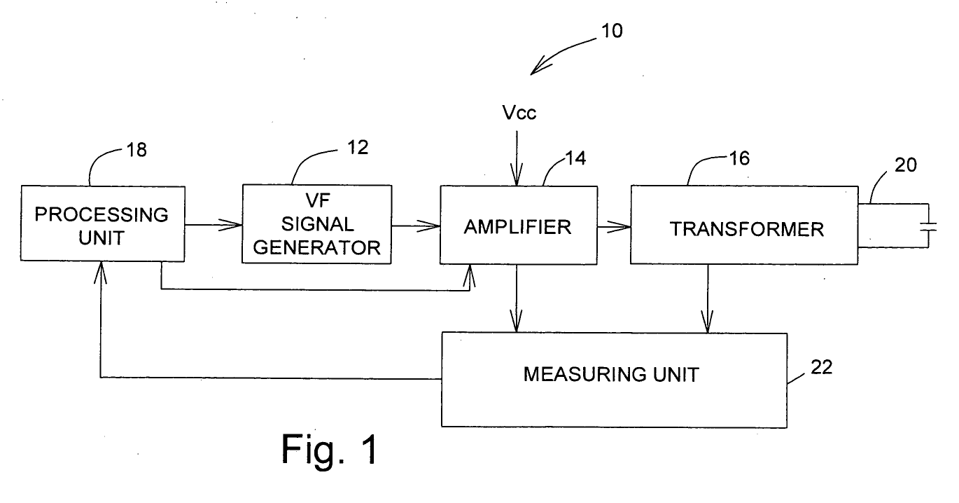

Turning first to FIG. 1, there is shown a first embodiment 10 of the invention. A signal generator 12 emits a variable frequency signal, which is received by an amplifier 14. In turn, amplifier 14 transmits an amplified variable frequency signal to a transformer 16 that steps up the amplified variable frequency signal to create an output voltage corresponding to a desired voltage.

Signal generator 14 is typically a variable frequency oscillator (“VFO”) and has a frequency that is controlled by a processing unit 18, while transformer 16 is designed to resonate with the capacitance of a load 20 at the desired frequency of operations.

A measuring unit 22 measures the amount of power consumed by amplifier 14 during the amplification process and generates a reading, which is transmitted to processing unit 18. Based on that reading, processing unit 18 tunes variable frequency generator 12, causing it to emit the variable frequency signal at the frequency of resonance of transformer 16. Therefore, because transformer 16 is made to operate at its frequency of resonance, all power losses related to stray capacitance and stray inductance are minimized, and the self tuning high voltage power supply is enabled to operate with minimum power consumption. While measuring unit 22 and processing unit 18 are shown as separate units, their functions may be integrated into a single control unit.

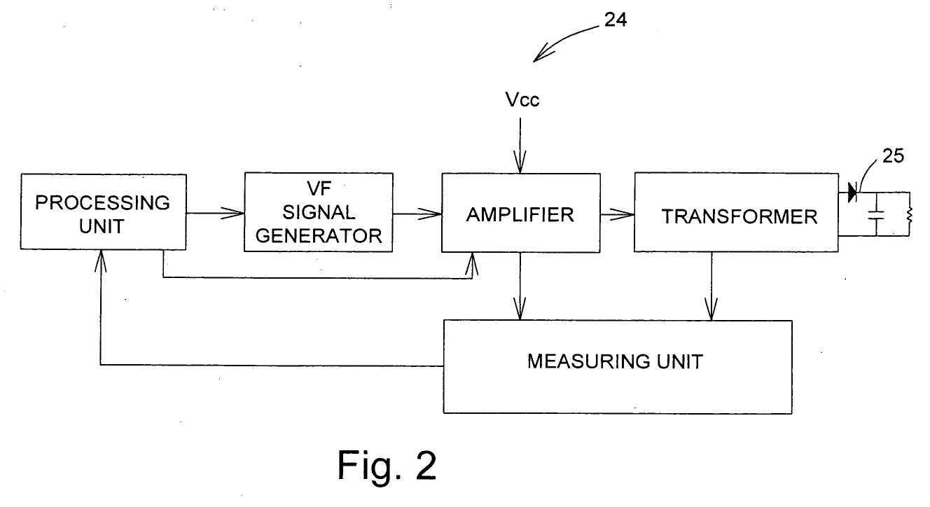

Embodiment 10 is particularly suited for inverting a DC power input (indicated as V_{cc} in FIG. 1) into an AC output at load 20. A second embodiment 24, illustrated in FIG. 2, is instead particularly suited for non-inverting a DC power input into a DC output at load 25 due to the addition of a rectifier circuit at load 25.

Other embodiments of the invention comprise different variants of the above described components. In one embodiment, the VFO may be tuned by processing unit 18 in a continuous manner over a predetermined frequency range; in another embodiment, the VFO may be tuned in discrete steps over the frequency range. In still another embodiment, signal generator 12 is a direct digital synthesis frequency generator that allows for ultra-fast and phase continuous frequency switching.

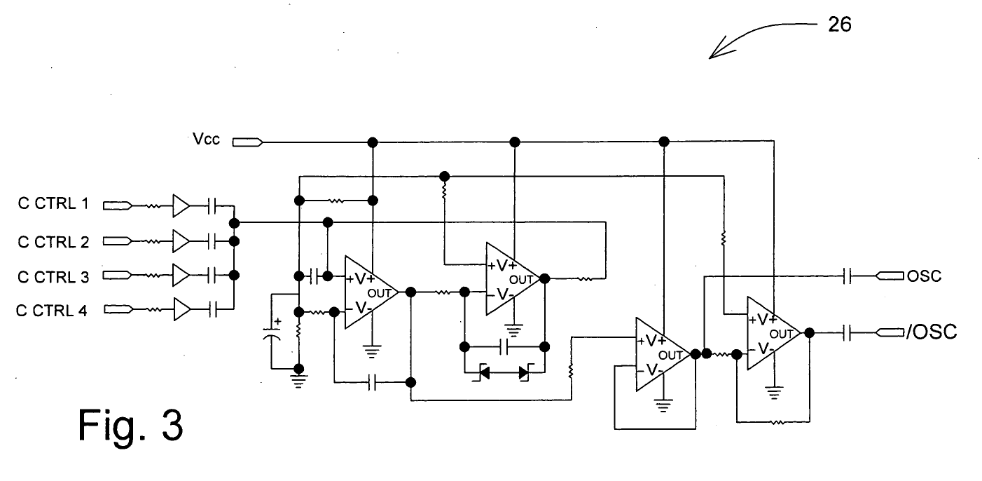

FIG. 3 shows a detailed circuit diagram of a VFO 26 that, in the illustrated example, is a variable Wien Bridge Oscillator and that can be tuned from a minimum frequency f₀ₘᵢₙ to a maximum frequency f₀ₘₐₓ in a number “n” of steps (in the illustrated example, 16 steps). Four binary weighed capacitors serve as the tuning element and can be switched in and out by means of semiconductor analog switches.

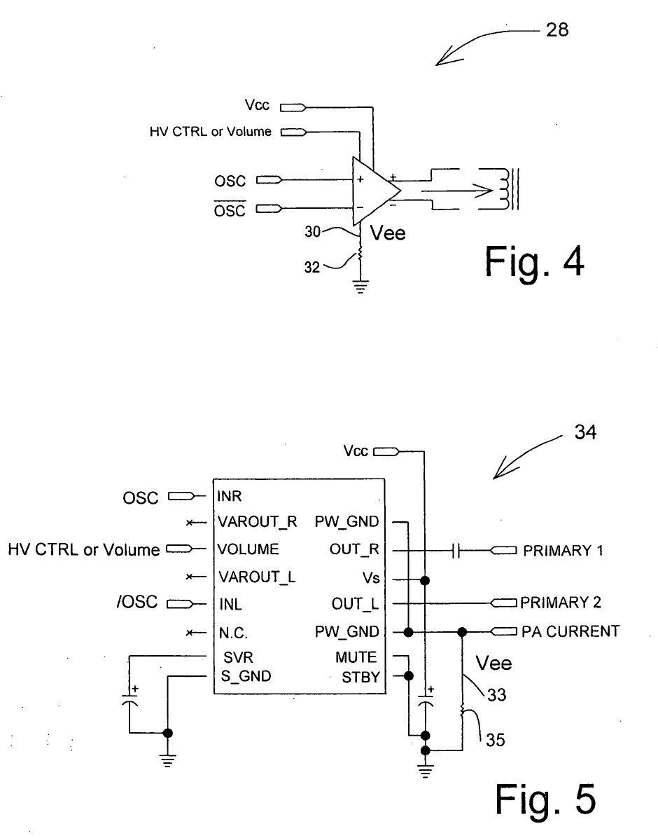

Turning now to FIG. 4, there is shown a summary circuit diagram of a power amplifier 28. The collector power supply line is typically a V_{cc} or V_{dd} line, while the emitter power supply line is typically a Vₑₑ or Vₛₛ line. In one embodiment of the invention, power amplifier 28 is a commercially available, integrated circuit power amplifier, of the type used in home theaters or in car radio receivers. In another embodiment, power amplifier 28 is custom-designed from discrete components and/or integrated circuits. In a further embodiment, power amplifier 28 is a linear amplifier of class A, AB, or B, or a high efficiency switching amplifier of class D. Different types of high efficiency switching amplifiers include single stage, push-pull, half bridge, or full bridge power supply switching circuits.

In the illustrated embodiment, the Vₑₑ power supply line 30 is connected to the ground. The return current of amplifier 28 passes through resistor 32, generating a small voltage that is proportional to the current consumed, and hence represents the power consumed, since the V_{cc} (input) power supply line has a constant voltage. Measuring unit 22 can then measure the voltage at the opposite ends of resistor 32, and provide a reading to processing unit 18 of the power consumed by amplifier 28.

In another embodiment, the emitter power supply line provides the input for a split or dual voltage power supply, for instance, a +15V/−15V DC supply. The power consumed by the amplifier can then be measured by inserting a current sampling resistor in that emitter power supply line.

In FIG. 5 there is shown a detailed circuit diagram of an amplifier circuit 34 (single part) that employs a car stereo amplifier integrated circuit. In the illustrated circuit, input from f₀ₘᵢₙ to f₀ₘₐₓ is at 1Vₚ₋ₚ, and an output instead of 20 W of power (in bridged mode) is directed into the primary winding of transformer 18. More particularly, amplifier circuit 34 exhibits a voltage input (shown as Volume) that controls its gain, which allows for a voltage controlled volume control and for a regulated, calibrated, and controlled output voltage. In this embodiment the power consumed by the amplifier is measured by measuring the voltage at the opposite ends of resistor 35, which is positioned in power supply return line 33.

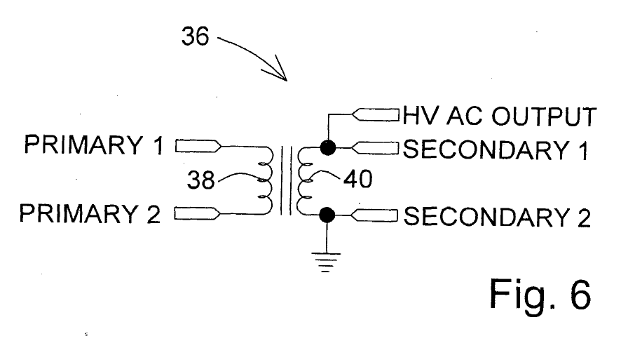

Turning now to FIG. 6, there is shown a summary circuit diagram of a transformer 36 that steps up the output of amplifier 14 and creates the desired high voltage, driving the load. Transformer 36 has typically a large step up ratio (a ratio between the secondary and primary turns of 5:1 or higher), which causes power losses in the windings during operation, due to the stray inductance and stray capacitance from turn to turn. As the step up ratio increases, that is, as the number of turns in the secondary winding is proportionally larger than the number of turns in the primary winding, the influence of the stray parameters tends to increase, absorbing more and more power that would otherwise be delivered to the load, and creating more and more heat that must be dissipated by the driving circuitry.

In the present invention, the high voltage power supply is designed to turn stray capacitance and stray inductance from a detrimental effect into a positive effect. More particularly, transformer 36 is designed to cause its output inductance to resonate with the load capacitance and the stray capacitance within the frequency range f₀ₘᵢₙ-f₀ₘₐₓ by changing the number of turns in the primary and secondary windings while maintaining the turns ratio unchanged, or by changing the number of turns in the primary and/or secondary winding and changing the turns ratio accordingly, or by changing the thickness of the air gap in the core of the transformer.

The frequency of resonance f₀ᵣₑₛ is determined as follows:

if

f₀=1/(2π)*(L*C)^{1/2}

f₀ₘᵢₙ<f₀ᵣₑₛ<f₀ₘₐₓ,

C_{equiv}=C_{stray}+C_{load}

then

f₀ᵣₑₛ=1/(2π)*(L_{sec}*C_{equiv})^{1/2}

f₀ₘᵢₙ=1/(2π)*(L_{sec}*C_{quiv max})^{1/2}

f₀ₘₐₓ=1/(2π)*(L_{sec}*C_{quiv min})^{1/2}.

One or more electrostatic discharge elements provide the load of the self tuning high voltage power supply. Typically, such electrostatic discharge elements behave like (and may comprise) capacitors, however, the load may be either AC in nature, and comprise a capacitive load, a resistive load, or a combination thereof, or DC in nature, and comprise a rectifier device (such as a diode), a filter device (such as a capacitor), and a resistive load. These electrostatic discharge elements can be switched in and out, according to the load requirements, causing the load capacitance to change. The self tuning high voltage power supply is then able to retain its high efficiency of operation by means of a self-calibration process.

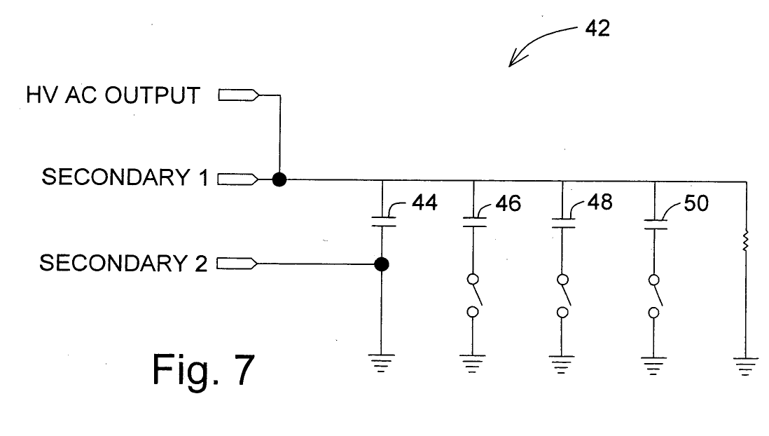

FIG. 7 shows an ion discharge load circuit 42, such as those found in color printers, and illustrates one example of an arrangement of the electrostatic discharge elements. In this example, the required loads might be related to black and white printing, or to color printing using three colors, or to printing in black and three colors. When printing in black and white, only the load from capacitor 44 is employed. Instead, when printing in three colors, each color relates to capacitors 46, 48, and 50, and, when printing in black and white and three colors, the loads of all four capacitors 44, 46, 48, and 50 are employed. When only capacitor 44 is employed, there is no need to re-tune the power supply, but when two or more capacitors are employed, the self tuning high voltage power supply re-calibrates itself as the load capacitance changes.

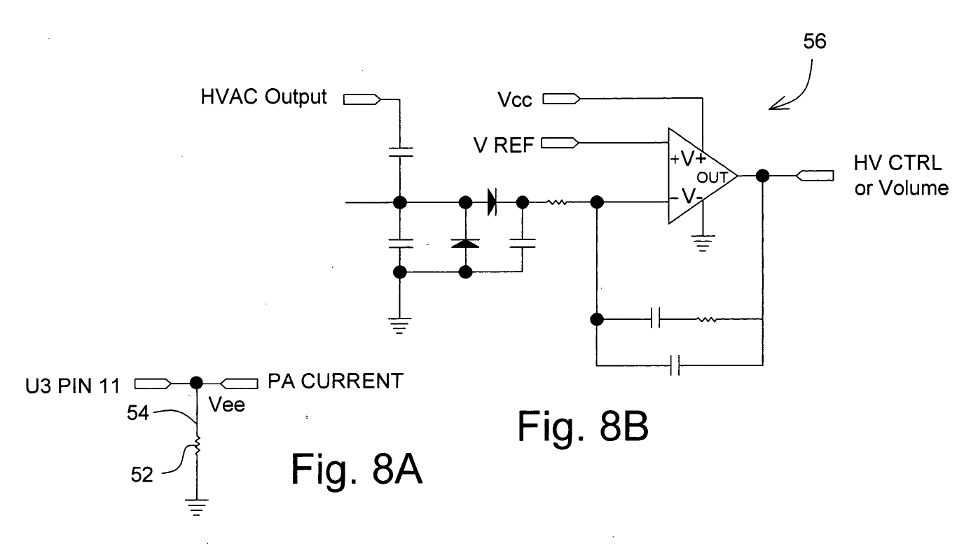

The operation of measuring unit 22 may be appreciated upon reference to FIGS. 8A-8B. As previously described and as shown in FIG. 8A, the power consumed by amplifier 14 is measured by inserting a sampling resistor 52 within the Vₑₑ power supply line 54 deriving from amplifier 14, and by measuring the voltage at the opposite ends of sampling resistor 52. Vₑₑ supply line 54 may be connected to the ground, or provide the power input to a split or dual voltage power supply.

Typically, measuring unit 22 comprises one or more measuring circuits that provide one or more readings to processing unit 18. To meet certain load requirements, it may be necessary to maintain the voltage output of the self tuning high voltage power supply at a constant level. FIG. 8B illustrates a detailed circuit diagram of a feedback network 56 that meets that requirement by means of a process called “system gain leveling.” Feedback network 56 samples the high voltage output of the self tuning high voltage power supply, then creates a low voltage AC or DC signal that is proportional to the required AC or DC output voltage, and feeds that signal back to measuring unit 22, where the control voltage is compared to a reference voltage. A second signal (shown as HV CRTL or Volume) is then created that is fed to a stage gain control input of amplifier 14, in order to set the gain of the amplifier stage. This insures that the amplified power signal delivered to the transformer is at a level appropriate to maintain a constant high voltage output level. Feedback network 56 may be integrated within measuring unit 22 or be a separate component

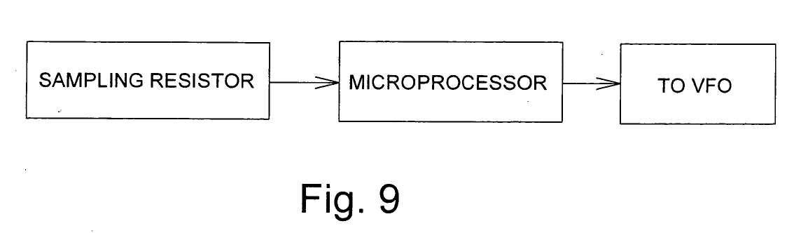

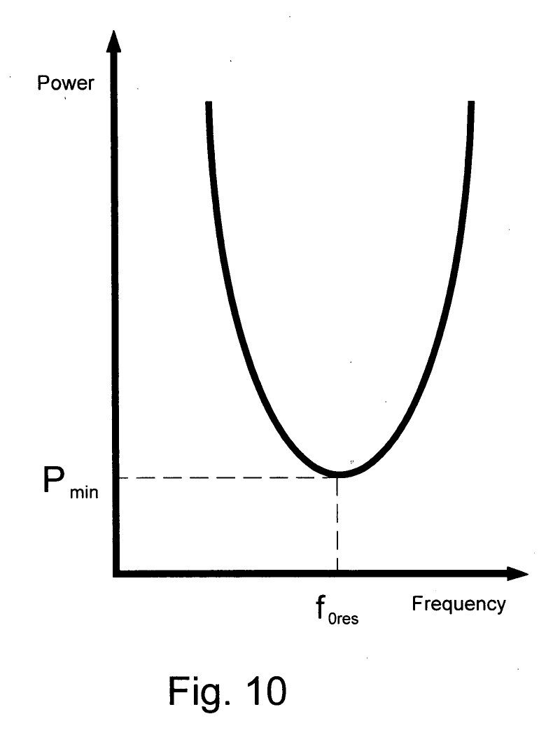

The operating frequency that produces the desired output level with minimum power consumption is determined by processing unit 18, which is typically a microprocessor. That operating frequency, the frequency of resonance, is influenced by a variety of factors, including loading conditions and environmental conditions, and may vary over time. Processing unit 18 performs a tuning routine by sweeping the frequency of the VFO over its range and by setting the desired frequency in operation for a predetermined period. The operating frequency is then checked at predetermined intervals and is adjusted as appropriate. The tuning routine is summarized in the schematic diagram of FIG. 9, while FIG. 10 shows the qualitative relationship between the power, as measured at the sampling resistor, and the frequency as selected during the tuning routine. Pₘᵢₙ represents the point of minimum power consumption, which occurs at resonance frequency f₀ᵣₑₛ.

In one embodiment of the invention, the microprocessor in processing unit 18 reads the output of measuring unit 22 by means of an Analog to Digital Converter (“ADC”), which then performs a sequence of switching in and out four capacitors having values C, 2C, 4C, and 8C. These four capacitors tune the VFO, so that the input current to amplifier 14 is at a minimum, representing the highest efficiency with the high voltage power supply operating in resonance. The microprocessor also reads the output voltage of the high voltage power supply and adjusts it to the desired voltage, maintaining regulation under various load conditions.

While the invention has been described in connection with the above described embodiments, it is not intended to limit the scope of the invention to the particular forms set forth, but on the contrary, it is intended to cover such alternatives, modifications, and equivalents as may be included within the scope of the invention.

The present invention finds industrial applicability in a variety of fields, where high voltage must be provided. Out of the many possible applications, a few specific examples are:

(a) Miniature DC-DC converters for ink jet printing, electrostatic precipitation, Geiger-Muller tubes, and electron beam deflection and focusing;

(b) Photomultiplier power supplies for photomultipliers, solid state detectors, piezo crystal devices, ultrasonic transducers, spectroscopy, scintillation counters, pollution detection, pattern recognition, and channel electron multipliers;

(c) Precision scientific modules for electron beam deflection, electro-rheological fluids, and micro-channel plates;

(d) Flat pack high voltage supplies for ultrasonic transducers, and gamma cameras;

(e) Versatile high voltage power supplies for projection TV's and ion acceleration;

(f) Ion pump power supplies for mass spectrometers, scanning electron microscopes, and high integrity vacuum systems; and

(g) Power supplies for ion implantation, ion vapor deposition, chemical vapor deposition, electron guns, high voltage testing, particle accelerators, lasers, and PC boards.

I claim:

1. A self tuning high voltage power supply comprising:
(a) a signal generator emitting a variable frequency signal;
(b) an amplifier receiving said variable frequency signal and emitting an amplified variable frequency signal;
(c) a transformer receiving and stepping up said amplified variable frequency signal, said transformer creating an output voltage corresponding to a desired voltage;
(d) a control unit measuring the power consumed by said amplifier and tuning said signal generator to emit said variable frequency signal at the frequency of resonance of said transformer,
wherein the operation of said transformer at said frequency of resonance substantially eliminates the power losses due to stray capacitance and stray inductance, thereby causing said self tuning high voltage power supply to deliver the desired voltage with minimum power consumption.

2. The self tuning high voltage power supply of claim 1, wherein said control unit comprises a measuring unit measuring the power consumed by said amplifier and providing a reading, and a processing unit receiving said reading and tuning said signal generator to emit said variable frequency signal at said frequency of resonance of said transformer.

3. The self tuning high voltage power supply of claim 2, wherein said measuring unit comprises measuring circuits.

4. The self tuning high voltage power supply of claim 2, wherein said processing unit comprises a microprocessor.

5. The self tuning high voltage power supply of claim 4, wherein said microprocessor reads said output voltage of said transformer and adjusts said output voltage to said desired voltage, thereby maintaining regulation of the self tuning high voltage power supply under different load conditions.

6. The self tuning high voltage power supply of claim 1, wherein said signal generator is a variable frequency oscillator.

7. The self tuning high voltage power supply of claim 6, wherein said variable frequency oscillator is capable of being tuned by said processing unit in a continuous manner between a minimum frequency and a maximum frequency.

8. The self tuning high voltage power supply of claim 6, wherein said variable frequency oscillator is capable of being tuned by said processing unit in discrete steps between a minimum frequency and a maximum frequency.

9. The self tuning high voltage power supply of claim 6, wherein said variable frequency oscillator is an oscillator that is capable of being tuned between a minimum frequency and a maximum frequency using a plurality of capacitors that are switched in and out by semiconductor analog devices.

10. The self tuning high voltage power supply of claim 9, wherein the oscillator is a Wien Bridge Oscillator.

11. The self tuning high voltage power supply of claim 10, wherein said variable frequency oscillator is a direct digital synthesis oscillator.

12. The self tuning high voltage power supply of claim 1, wherein said amplifier comprises integrated circuits.

13. The self tuning high voltage power supply of claim 1, wherein said amplifier is a linear amplifier.

14. The self tuning high voltage power supply of claim 1, wherein said amplifier is a high efficiency switching amplifier.

15. The self tuning high voltage power supply of claim 14, wherein said amplifier is single stage, push-pull, half bridge, or full bridge power supply switching circuits.

16. The self tuning high voltage power supply of claim 1, wherein said amplifier further comprises a collector power supply line and an emitter power supply line.

17. The self tuning high voltage power supply of claim 16, wherein said collector power supply line is of the V_{cc} or V_{dd} type.

18. The self tuning high voltage power supply of claim 16, wherein said emitter power supply line is of the Vₑₑ or Vₛₛ type.

19. The self tuning high voltage power supply of claim 16, wherein the power consumed by said amplifier is measured by inserting a sampling resistor in the emitter power supply line and by measuring the voltage at the opposite ends of the sampling resistor.

20. The self tuning high voltage power supply of claim 1, wherein the load provided by said self tuning high voltage power supply comprises one or more electrostatic discharge elements that are configured to be switched in and out according to load requirements.

21. The self tuning high voltage power supply of claim 20, wherein said one or more discharge elements comprise capacitors.

22. The self tuning high voltage power supply of claim 20, wherein said transformer comprises a primary winding and a secondary winding each having a plurality of turns in a given ratio, and wherein the output inductance of said transformer is made to resonate with the capacitance of said one or more electrostatic discharge elements by varying said ratio.

23. The self tuning high voltage power supply of claim 22, wherein said transformer comprises a primary winding and a secondary winding each having a plurality of turns in a given ratio, and wherein the output inductance of said transformer is made to resonate with the capacitance of said one or more electrostatic discharge elements by varying the plurality of turns without varying said ratio.

24. The self tuning high voltage power supply of claim 20, wherein said transformer comprises a primary winding and a secondary winding each having a plurality of turns, wherein said primary winding and said secondary winding are each wound on a core having an air gap, and wherein the output inductance of said transformer is made to resonate with the capacitance of said one or more electrostatic discharge elements by varying said gap.

25. The self tuning high voltage power supply of claim 20, wherein said transformer comprises a primary winding and a secondary winding each having a plurality of turns in a given ratio, wherein said primary winding and said secondary winding are each wound on a core having an air gap, and wherein the output inductance of said transformer is made to resonate with the capacitance of said one or more electrostatic discharge elements by varying said ratio and said gap.

26. The self tuning high voltage power supply of claim 1, wherein said output voltage is maintained at a constant level, wherein said amplifier further comprises a gain control input, and wherein said high voltage power supply further comprises a feedback network, the operation of said feedback network comprising the steps of:
(a) sampling said high voltage output;
(b) creating a low voltage signal proportional to said high voltage output;
(c) feeding said low voltage signal to said control unit;
(d) comparing said high voltage output to a reference voltage; and
(e) creating an amplifier signal that is fed to said amplifier gain control input to set the gain at said amplifier and to cause said amplifier to emit said amplified variable frequency signal to said transformer at a level appropriate to maintain said high voltage output at the constant level.

27. The self tuning high voltage power supply of claim 26, wherein said feedback network is integrated within said control unit.

28. The self tuning high voltage power supply of claim 27, wherein said control unit comprises a microprocessor reading the measurement of the power consumed by said amplifier with an analog to digital converter, wherein said signal generator is tuned with one or more capacitors, and wherein said analog to digital converter performs a sequence of switching in and out said on or more capacitors in order to minimize input current to said amplifier.

29. A method for generating a self tuning high voltage power supply comprising the steps of:
(a) generating a variable frequency signal;
(b) amplifying said variable frequency signal to provide an amplified variable frequency signal;
(c) stepping up said amplified variable frequency signal with a transformer to create an output voltage corresponding to a desired voltage; and
(d) measuring the power consumed to provide said amplified variable frequency signal and tuning said variable frequency signal to the frequency of resonance of said transformer, thereby recovering and delivering to the load substantially all power lost to stray capacitance and to stray inductance in the transformer, and thereby causing said self tuning high voltage power supply to provide said desired voltage with minimum power consumption.
